(19) United States
(12) Patent Application Publication
(10) Pub. No.: US 2018/0271336 A1
(43) Pub. Date: Sep. 27, 2018

(54) MULTI-FUNCTION AUTOMATIC LIQUID SOAP DISPENSER

(71) Applicant: Garfield Ron Mingo, East Orange, NJ (US)

(72) Inventor: Garfield Ron Mingo, East Orange, NJ (US)

(21) Appl. No.: 15/468,922

(22) Filed: Mar. 24, 2017

(51) Int. Cl. A47K 3/28; A47K 7/02; A47K 5/12; H04R 1/02; H04R 3/00

(52) U.S. Cl. CPC A47K 3/281; A47K 7/024; A47K 5/1217; H04R 2420/07; H04R 3/00; A47K 2201/02; H04R 1/028

(57) ABSTRACT

An automatic liquid personal hygiene product dispenser having a housing and a plurality of liquid product containers within a cavity of the housing. At least one container is in communication with an automatic dispensing nozzle. Another container is in communication with a manual dispensing nozzle. The automatic dispenser is controlled via circuitry to display a dispensing rate for the automatic dispenser, with controls for setting the dispensing rate. A wireless speaker is carried within the housing and may be paired with an external portable electronic device. With my product being a multipurpose bathroom product it will clear up some clutter in the bath area, help you get soap onto your back much easier, while playing music to make your bath experience much more fun and relaxing.

### BACKGROUND OF THE INVENTION

The present invention relates to dispensers for personal hygiene products and, more particularly, automatic liquid soap dispensing apparatus.

Many people have too many liquid personal hygiene product containers in their shower area, causing a clutter. Also there are many times when we take a shower it is hard for us to reach every part of our backs. Similarly, many of the other shower and bath products don't fulfill as many of the bathroom bath products. For example, some products only play music but do not function as bath product organizers to get rid of clutter. Likewise, while some products may hold and dispense liquid soap, they do not play music.

As can be seen, there is a need for an improved a multi-purpose shower and bath product that will organize personal hygiene products in the bath area.

### SUMMARY OF THE INVENTION

In one aspect of the present invention, a multi-function liquid personal hygiene product dispenser for a bath enclosure is disclosed. The dispenser has a housing defining an interior cavity therein. A plurality of containers are carried within the interior cavity, and are configured to receive a volume of the liquid personal hygiene product. At least one automatically controlled nozzle is provided for dispensing the liquid personal hygiene product from at least one of the plurality of containers and at least one manually controlled nozzle for dispensing the personal hygiene product from at least one of the plurality of containers.

In some embodiments, the multi-function liquid personal hygiene product includes a control for setting a dispensing rate of the at least one automatically controlled nozzle and a display for presenting the dispensing rate setting. The dispenser may also include a wireless speaker carried within the housing, control circuitry for pairing the wireless speaker with a portable electronic device; and a control for selectively playing an audio signal from the portable electronic device on the speaker.

In other embodiments, at least one hook extends from an exterior surface of the housing, configured to hold a bath accessory. The bath accessory may be a back scrubbing brush. The automatically controlled nozzle may also be configured to articulate in order to dispense the personal hygiene product in a selected direction. The manually controlled nozzle comprises a stopcock.

The multi-function liquid dispenser may also include a mounting element, which may be a suspension device extending from an upper surface of the housing. The mounting element may also include a suction cup operatively attached to a back surface of the housing and configured for cooperative engagement with a surface of the bath enclosure.

These and other features, aspects and advantages of the present invention will become better understood with reference to the following drawings, description and claims.

### BRIEF DESCRIPTION OF THE DRAWINGS

FIG. 1 is a front top perspective view of an embodiment of the multi-function dispenser of the present invention.

FIG. 2 is a front bottom perspective view of the multi-function dispenser shown in use.

FIG. 3 is a front bottom perspective view of the multi-function dispenser.

FIG. 4 is a rear bottom perspective view of the multi-function dispenser.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved a multi-function bath and shower organizer and dispenser. The dispenser is configured for manual dispensing and also a hands free mode to automatically deliver a liquid hygiene product to a targeted area of a person's body. It may also be configured with a speaker system to play audio files, a hook for storing other personal hygiene products.

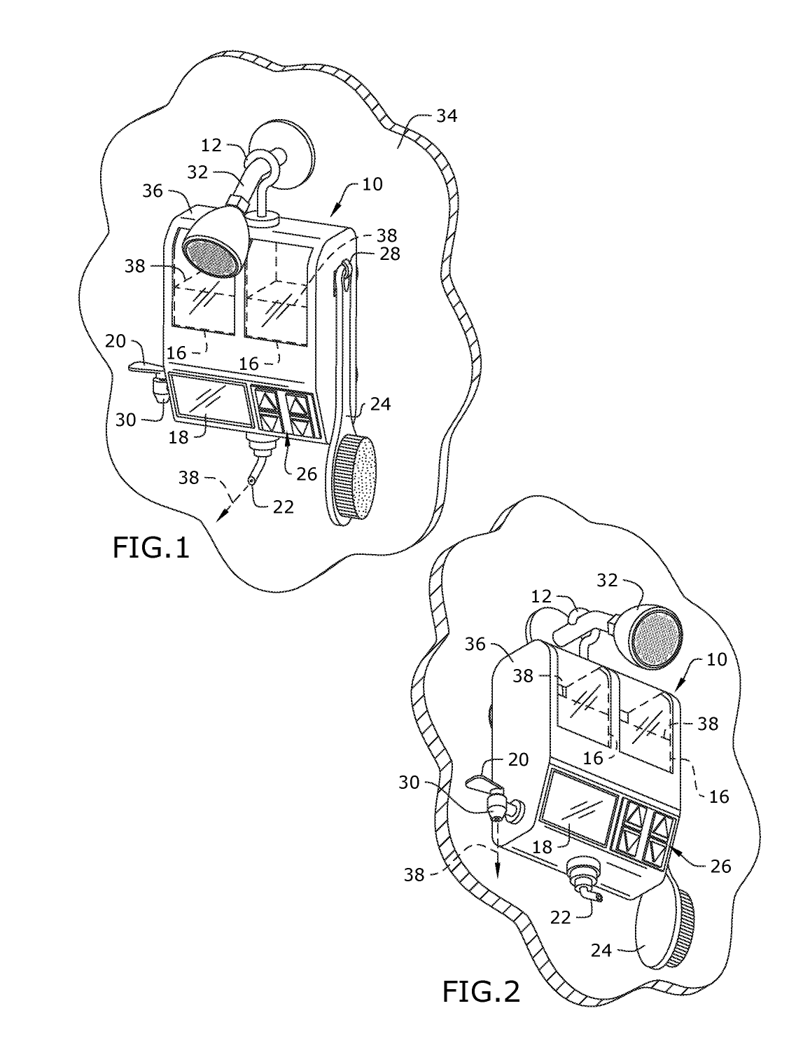

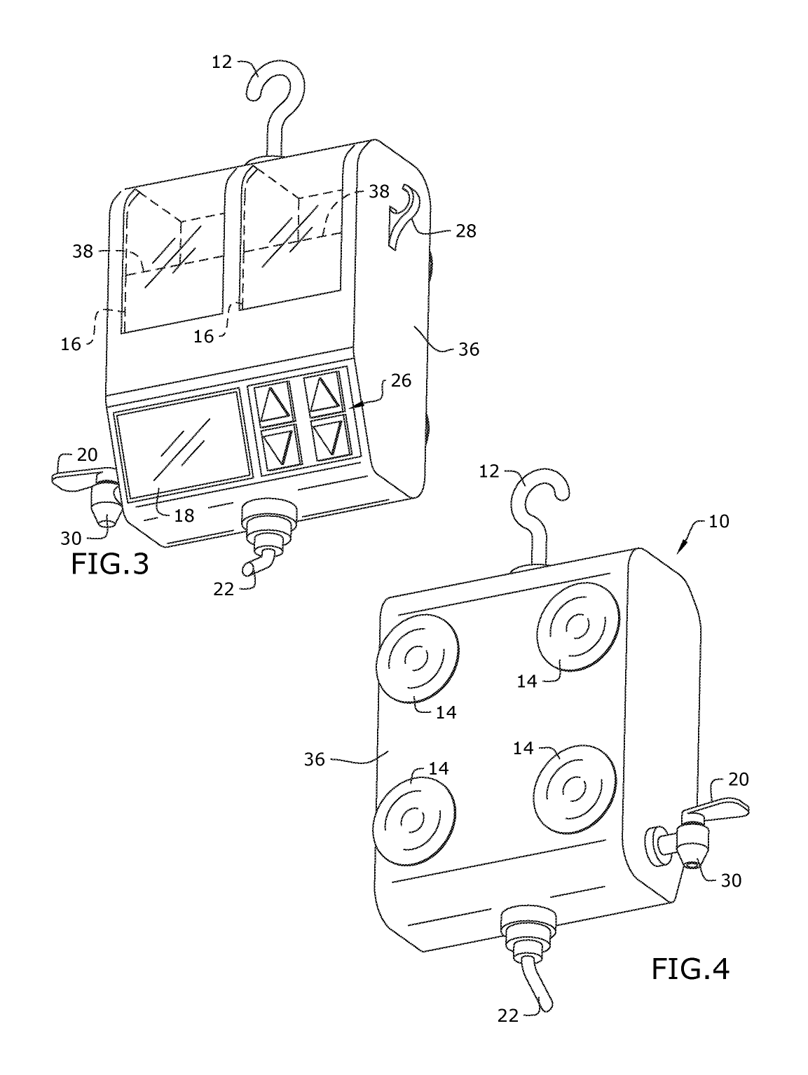

As seen in reference to the drawings of FIGS. 1-4, the automatic multi-function soap dispenser 10 of the present invention includes a housing 36 that is configured to mount within a bath or shower enclosure 34. The mount may include one of a suspension mount 12, such as a hook, that may be suspended from an extension tube 32 of a shower head. The mount may also include one or more suction cups 14 operatively attached to a back surface of the housing 36.

A plurality of containers 16 are carried within an interior cavity of the housing 36. The containers 16 are configured to contain a volume of a liquid personal hygiene product 38, such as soap, shampoo, conditioner, or a skin lotion. The containers 16 are in fluid communication with a dispensing nozzle, which may be one of a manual dispenser nozzle 30 or an automatic dispensing nozzle 22. The manual dispenser nozzle 30 includes a manual dispenser control 20, such as a lever, or stopcock, that is operable to deliver a flow of the liquid hygiene product 28 from the container 16.

The automatic dispensing nozzle 22 is configured to articulate or be oriented by the user to deliver a stream of liquid hygiene product 28 to a desired portion of the user's body. The automatic dispensing nozzle 22 may be programmed via control buttons 26 to select a desired delivery rate or time interval for dispensing the liquid hygiene product 28. The housing 36 may also include a display 18, such as a liquid crystal display screen, to provide a visual indication of the desired delivery rate or time interval of the automatic dispensing nozzle 22. A pumping unit (not shown) may be carried within the housing 36 to dispense the liquid hygiene product 28 as a pressurized stream. The pumping unit may be powered by an internal battery carried within the housing 36.

The housing 36 may also have one or more hooks 28 extending from an outer surface. One or more personal hygiene tools 24, such as a back scrubbing brush, a wash cloth, an exfoliating scrubber, or the like may be suspended from the hooks 28 so as to provide a convenient holding and organization for the tools 24.

The housing 36 may also be configured to contain circuitry for wirelessly connecting an internal speaker system to allow the user to listening to audio files played by a portable electronic device, such as an MP3 player, a smartphone or a tablet device. The circuitry may include a Bluetooth connection to the portable electronic device. The housing 36 may also contain a microphone to permit the user to wirelessly transmit their voice, such as for conducting a telephone conversation, voice commands for the portable electronic. The speaker system and wireless connection may be controlled via the control buttons 26 and the LCD display 18.

It should be understood, of course, that the foregoing relates to exemplary embodiments of the invention and that modifications may be made without departing from the spirit and scope of the invention as set forth in the following claims.

What is claimed is:

1. A multi-function liquid personal hygiene product dispenser for a bath enclosure, comprising:
a housing defining an interior cavity therein;
a plurality of containers carried within the interior cavity, the plurality of containers configured to receive a volume of the liquid personal hygiene product;
at least one automatically controlled nozzle for dispensing the liquid personal hygiene product from at least one of the plurality of containers; and
at least one manually controlled nozzle for dispensing the personal hygiene product from at least one of the plurality of containers.

2. The multi-function liquid personal hygiene product dispenser of claim 1, further comprising:
a control for setting a dispensing rate of the at least one automatically controlled nozzle; and
a display for presenting the dispensing rate setting.

3. The multi-function liquid personal hygiene product dispenser of claim 2, further comprising:
a wireless speaker carried within the housing;
a control circuitry for pairing the wireless speaker with a portable electronic device; and
a control for selectively playing an audio signal from the portable electronic device on the speaker.

4. The multi-function liquid personal hygiene product dispenser of claim 3, further comprising:
at least one hook extending from an exterior surface of the housing, configured to hold a bath accessory.

5. The multi-function liquid personal hygiene product dispenser of claim 4, wherein the bath accessory is a back scrubbing brush.

6. The multi-function liquid personal hygiene product dispenser of claim 1, wherein the automatically controlled nozzle articulates to dispense the personal hygiene product in a selected direction.

7. The multi-function liquid personal hygiene product dispenser of claim 1, wherein the manually controlled nozzle comprises a stopcock.

8. The multi-function liquid personal hygiene product dispenser of claim 1, further comprising:
a mounting element.

9. The multi-function liquid personal hygiene product dispenser of claim 8, wherein the mounting element comprises a suspension device extending from an upper surface of the housing.

10. The multi-function liquid personal hygiene product dispenser of claim 8, wherein the mounting element comprises:
a suction cup operatively attached to a back surface of the housing and configured for cooperative engagement with a surface of the bath enclosure.
